(19) United States
(12) Patent Application Publication
(10) Pub. No.: US 2010/0138191 A1
(43) Pub. Date: Jun. 3, 2010

(54) METHOD AND SYSTEM FOR ACQUIRING AND TRANSFORMING ULTRASOUND DATA

(76) Inventor: James Hamilton, Brighton, MI (US)

Correspondence Address: SCHOX PLC, 500 3rd Street, Suite 515, San Francisco, CA, 94107, US

(21) Appl. No.: 12/625,875

(22) Filed: Nov. 25, 2009

Related U.S. Application Data
(63) Continuation-in-part of application No. 11/781,217, filed on Jul. 20, 2007.
(60) Provisional application No. 60/807,876, filed on Jul. 20, 2006.
(60) Provisional application No. 60/807,879, filed on Jul. 20, 2006.
(60) Provisional application No. 60/807,880, filed on Jul. 20, 2006.
(60) Provisional application No. 61/145,710, filed on Jan. 19, 2009.

(51) Int. Cl. G06F 15/00

(52) U.S. Cl. 702/189

(57) ABSTRACT

A method and system for transforming acquired ultrasound data for processing that includes the steps of generating ultrasound data, calculating object motion, modifying a data generation parameter using the calculated object motion, processing the ultrasound data related to the generated ultrasound data, and outputting the processed data. The method and system may additionally include buffering data from a data acquisition device.

### CROSS-REFERENCE TO RELATED APPLICATIONS

This application is a continuation-in-part of prior application Ser. No. 11/781,217, filed 20 Jul. 2007 and entitled “Method of Modifying Data Acquisition Parameters of an Ultrasound Device”, which claims the benefit of US Provisional Application number 60,807,876 filed 20 Jul. 2006 and entitled “Multi-Resolution Tissue Tracking”, U.S. Provisional Application No. 60/807,879 filed 20 Jul. 2006 and entitled “Data Acquisition Methods for Ultrasound Based Tissue Tracking”, U.S. Provisional Application No. 60/807,880 filed 20 Jul. 2006 and entitled “Data Display and Fusion”. This application also claims the benefit of U.S. Provisional Application No. 61/145,710 filed 19 Jan. 2009 and entitled “Dynamic Ultrasound Acquisition and Processing Using Object Motion Calculation”. The patent application and the four provisional applications are all incorporated in their entirety by this reference.

### STATEMENT REGARDING FEDERALLY SPONSORED RESEARCH OR DEVELOPMENT

This invention was supported by a grant from the National Heart, Lung, and Blood Institute (#5R44HL071379), and the U.S. government may therefore have certain rights in the invention.

### TECHNICAL FIELD

This invention relates generally to the medical ultrasound field, and more specifically, to a new and useful method and system for acquiring and transforming ultrasound data.

### BACKGROUND

Ultrasound technologies for accurately measuring tissue motion and deformation, such as speckle tracking and tissue Doppler imaging, have provided significant advances for applications such as breast elastography and cardiac strain rate imaging. However, there are significant computational challenges involved with the processing of ultrasound data. One challenge is producing suitable volume acquisition and data processing rates, especially for 3D data. For example, a typical image plane composed of a 100 ultrasound beams would be collected 100 times faster than a fully sampled volume of 10,000 beams (100×100 beams). Unfortunately, high acquisition and measurement rates are needed for many applications, such as those in cardiology and vascular fields. This can be particularly problematic for speckle tracking and other technologies that require a high level of coherence between measurements. Thus, there is a need in the ultrasound processing field to create a new and useful method and system for acquiring and transforming ultrasound data. This invention provides such a new and useful method and system.

### BRIEF DESCRIPTION OF THE FIGURES

FIG. 1 is a flowchart of a first preferred embodiment of the method for acquiring and transforming ultrasound data;

FIG. 2A is a variation of the first preferred embodiment;

FIG. 2B is a detailed flowchart of a cycle of ultrasound device modification for dynamic acquisition;

FIG. 3 is a variations of the first preferred embodiment;

FIGS. 4 and 5 are flowcharts of variations of the second preferred embodiment; and

FIGS. 6 and 7 are flowcharts of the preferred embodiments of the systems for acquiring and transforming ultrasound data.

### DESCRIPTION OF THE PREFERRED EMBODIMENTS

The following description of preferred embodiments of the invention is not intended to limit the invention to these preferred embodiments, but rather to enable any person skilled in the art of ultrasound devices to make and use this invention.

### 1. Method

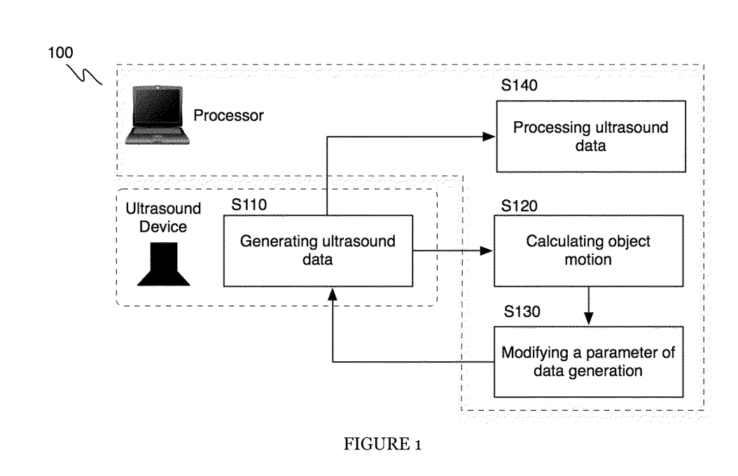

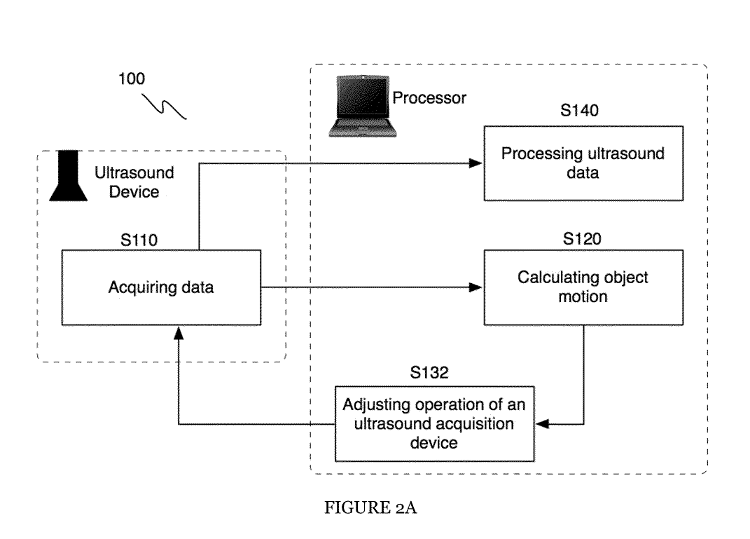

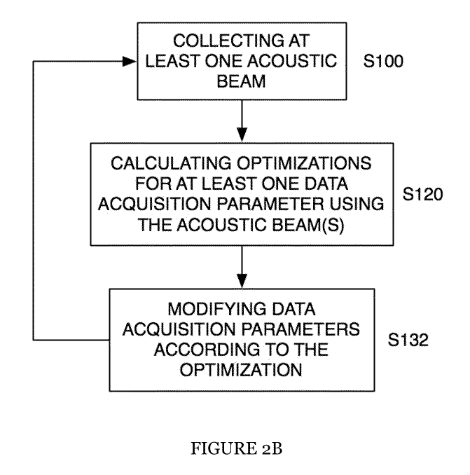

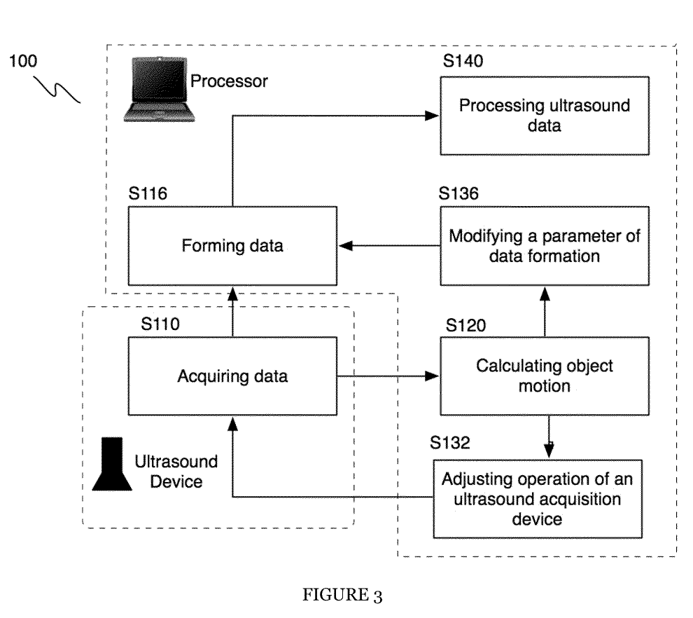

As shown in FIGS. 1, 2A, and 3, the method 100 of the first preferred embodiment includes generating ultrasound data S110, calculating object motion S120, modifying a parameter of data generation S130, and processing ultrasound data S140. The method 100 functions to use object motion information extracted from an original form of data (e.g., raw ultrasound data) to optimize the data for ultrasound processing in real-time. Steps S110 and S130 have several alternatives or additional sub-steps that preferably affect the generation of ultrasound data used for the processing. In a first variation (shown in FIG. 2A), Step S130 includes adjusting operation of an ultrasound data acquisition device S132. With this first variation, the method includes collecting at least one acoustic beam to acquire data. The method also includes calculating optimizations for at least one data acquisition parameter using the acoustic beams by sending the data to a data processing unit and to a motion calculation device. The calculated motion feeds back to the device acquiring the ultrasound data to optimize the collection of data by modifying data acquisition parameters according to the optimizations (shown in FIG. 2B). In a second variation (shown in FIG. 3), Step S130 and S110 include modifying parameters of data formation S136 and forming acquired data according to the modified parameters S116. The system may be used in any suitable ultrasound system including two dimensional (2D) ultrasound, three dimensional (3D) ultrasound, Doppler ultrasound, or any suitable form of ultrasound for any suitable processing application.

Step S110 includes generating ultrasound data and, more specifically, acquiring ultrasound data. Step S110 preferably includes the sub-steps of collecting data and preparing data. The step of collecting data functions to collect raw ultrasound data such as from an ultrasound transducer or device storing raw ultrasound data. The step of collecting data preferably includes collecting at least one acoustic beam. The ultrasound data acquisition device (e.g., the transducer and beamformer) preferably has control inputs that determine the manner of ultrasound data collection. The data collection is preferably controlled by at least one beamformer, which transmits and receives ultrasound signals. The raw ultrasound data may be represented by real or complex, demodulated or frequency shifted (e.g., baseband data), or any suitable representation of raw ultrasound data. Preparing data functions to perform preliminary processing to convert the raw data into a suitable form, such as brightness mode (B-mode), motion mode (M-mode), Doppler, or any other suitable form of ultrasound data. The acquired data may alternatively be left as raw ultrasound data, or the acquired data may alternatively be collected in a prepared data format from an outside device. In addition, pre- or post-beamformed data may be acquired. The acquired data may describe any suitable area (either 1D, 2D, 3D), or any suitable geometric description of the inspected material. The acquired data is preferably from an ultrasound device, but may alternatively be any suitable data acquisition system sensitive to motion. The acquired data may alternatively be provided by an intermediary device such as a data storage unit (e.g. hard drive), data buffer, or any suitable device. In variations of the preferred embodiment generating ultrasound data may include additional sub-steps such as steps to organize, buffer, or modify the acquired ultrasound data.

Step S120, which includes calculating object motion, functions to analyze the acquired data to detect tissue movement, probe movement, and/or any other motion that affects the acquired data. Object motion preferably includes any motion that affects the acquired data such as tissue motion, tissue deformation, probe movement, and/or any suitable motion. The measured motion may be a measurement of tissue velocity, displacement, acceleration, strain, strain rate, or any suitable characteristic of probe, tissue motion, or tissue deformation. Object motion is preferably calculated using the raw ultrasound data, but may alternatively use any suitable form of ultrasound data. At least two data sets (e.g., data images) acquired at different times are preferably used to calculate 1D, 2D or 3D motion. Speckle tracking is preferably used, but alternatively, Doppler processing, block matching, cross-correlation processing, lateral beam modulation, B-mode image variation, electrocardiogram (ECG) interpretation, respiratory monitoring, and/or any suitable method may be used. Speckle tracking is a motion tracking method implemented by tracking the position of a kernel (section) of ultrasound speckles that are a result of ultrasound interference and reflections from scanned objects. The pattern of ultrasound speckles is fairly similar over small motions, which allows for tracking the motion of the speckle kernel within a search window (or region) over time. Motion from speckle tracking can be calculated with various algorithms such as sum of absolute difference (SAD) or normalized cross correlation. The motion measurements may additionally be improved and refined using models of tissue motion to detect object motion patterns. The object motion (or motion data) is preferably used as parameter inputs in the modification of a data acquisition parameter in Step S130.

Step S130, which includes modifying a parameter of data generation, functions to alter the collection and/or organization of ultrasound data used for processing. Modifying a parameter of data generation preferably alters an input and/or output of data acquisition. As discussed above, the method may include a variety of sub-steps. The operation of the device collecting ultrasound data may be altered as in Step S132 and/or the acquired data may be altered prior to processing as in Steps S136 and S116.

Step S132, which includes adjusting operation of an ultrasound acquisition device, functions to adjust settings of an ultrasound acquisition device based on object motion data. The control inputs of the ultrasound data acquisition device are preferably altered according to the parameters calculated using the object motion. Adjusted data acquisition parameters are preferably communicated to the ultrasound beamformer for implementation. In addition, the user may invoke changes to the ultrasound acquisition manually based on displayed information. The following object motion information may be used to assess ultrasound acquisition parameters: tissue displacement, temporal and spatial variation (e.g., derivatives and variance) of tissue displacement, correlation magnitude, and spatial and temporal variation of correlation magnitude. The possible modified parameter(s) of data acquisition preferably include the transmit and receive beam position, beam shape, ultrasound pulse waveform, frequency, transmit rate (e.g., frame rate), firing rate, and/or any suitable parameter of an ultrasound device. For example, previous tracking results may indicate little or no motion in the image or motion in a portion of the image. The frame rate, local frame rate, or acquisition rate may be reduced to lower data rates or trade off acquisition rates with other regions of the image. As another example, the beam spacing can be automatically adjusted to match tissue displacements, potentially improving data quality (i.e., correlation of measurements).

Step S140, which includes processing ultrasound data, functions to transform the acquired data for ultrasound imaging, analysis, or any other suitable goal. The step of processing preferably aids in the detection, measurement, and/or visualizing of image features. After the processing of the ultrasound data is complete, the method preferably proceeds to outputting the processed data (i.e., transformed data). The outputted data may be used for any suitable operation such as being stored, displayed, passed to another device, or any suitable use. The step of processing may be any suitable processing task such as spatial or temporal filtering (e.g., wall filtering for Doppler and color flow imaging), summing, weighting, ordering, sorting, resampling, or other processes and may be designed for any suitable application. Preferably, Step S140 uses the data that was generated in Step S110. Step S140 is preferably performed in real-time on the ultrasound data while the data is being acquired, but may alternatively be performed offline or remotely on saved or buffered data.

Additionally or alternatively, as shown in FIG. 3, the method 100 of the first preferred embodiment may include the steps modifying a parameter of data formation S136 and forming data S116. The additional steps S136 and S116 function to decouple the image (data) formation stage from other processing stages. An image formation preferably defines the temporal and spatial sampling of the ultrasound data. Steps S136 and S116 are preferably performed as part of Step S130 and Step S110 respectively, and may be performed with or without modifying a parameter of an ultrasound acquisition device S132 or any other alternative steps of the method 100.

Step S136, which includes modifying a parameter of data formation, functions to use the calculated object motion to alter a parameter of data formation. A parameter of data formation preferably includes temporal and/or spatial sampling of image data points, receive beamforming parameters such as aperture apodization and element data filtering, or any suitable aspect of the data formation process.

Step S116, which includes forming data, functions to organize image data for ultrasound processing. Parameters based on object motion are preferably used in the data formation process. The data formation (or image formation) stage preferably defines the temporal and spatial sampling of the image data generated from the acquired or prepared ultrasound data. The formed data is preferably an ultrasound image. An ultrasound image is preferably any spatial representation of ultrasound data or data derived from ultrasound signals including raw ultrasound data (i.e., radio-frequency (RF) data images), B-mode images (magnitude or envelope detected images from raw ultrasound data), color Doppler images, power Doppler images, tissue motion images (e.g., velocity and displacement), tissue deformation images (e.g., strain and strain rate) or any suitable images. For example, using aperture data (i.e., pre-beamformed element data) samples may be formed along consecutive beams to produce data similar to traditional beamforming.

### 2. Method Using Buffered Data

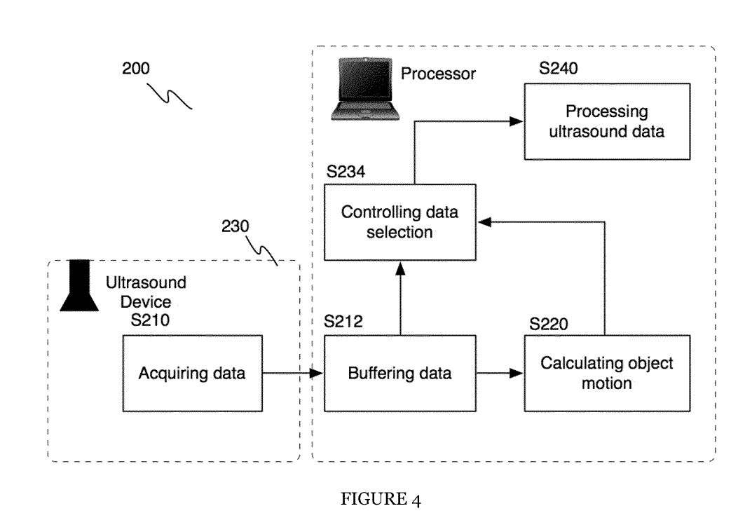

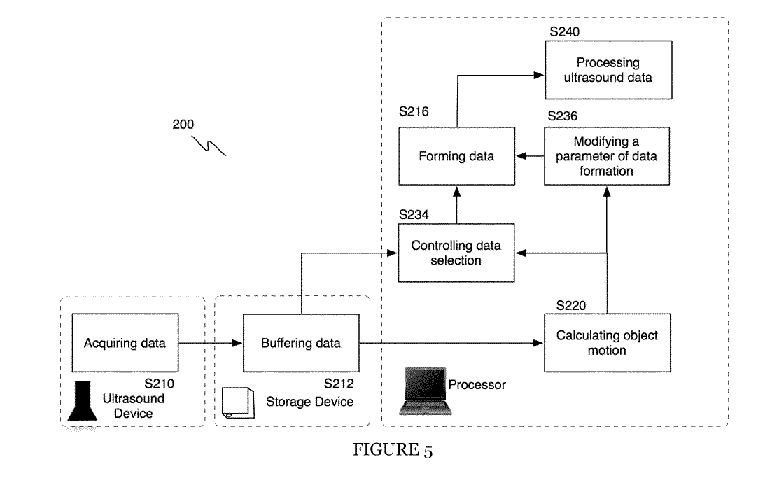

As shown in FIGS. 4 and 5, the method 200 of a second preferred embodiment is preferably similar to the above method 100 (of FIG. 1) and includes generating ultrasound data S210, calculating object motion S220, modifying a parameter of data generation S230, and processing ultrasound data S240. The method 200 is preferably applied to a buffered or intermediary data source specific embodiments of the second preferred embodiment of the method of dynamic ultrasound include the steps of generating ultrasound data S210 with buffering data S212, calculating object motion S220, controlling data selection S234, and processing ultrasound data S240. The method 200 of the second preferred embodiment functions to provide a method for dynamically selecting data for processing based on motion measurement(s) without directly altering an ultrasound data acquisition device. This may be beneficial in situations where modification of an ultrasound data acquisition device cannot be made or is not accessible. The method 200 additionally functions to improve 3D ultrasound data processing by buffering data to handle large volume acquisition and data processing rates necessary for 3D ultrasound applications. The method is preferably implemented in real-time or alternatively executed remotely on stored data. The Steps S210, S220, S230, and S240 of the second preferred embodiment are preferably identical to the Steps S110, S120, S130, and S140 of the first preferred embodiment respectively, except as noted below. Steps S210 and S230 preferably varies from Steps S110 and S130 to account for use of buffered data, but the various sub-steps of the two methods (e.g., S132, S136, S116, S234) may be used in any suitable combination. Controlling data selection S234, which is preferably one of the sub-step variations, functions to account for the use of buffered data. The method 200 preferably acquires raw data and provides the raw data to a data buffer or storage device. Step S210 may alternatively be performed by a remote device. The data buffer preferably sends the raw data to a data selection control unit and to an object motion calculation device. The calculated object motion is preferably used to alter the data selection process. The selected data is preferably processed by the data processor.

Step S212, which includes buffering data, functions to store data in an intermediary device before post processing. Step S212 additionally functions to decouple data processing from an acquisition device. The buffering of data may additionally be applied to large data sets such as 3D ultrasound data. The ultrasound data source may be any suitable device that can interface with the data buffer, preferably an ultrasound data acquisition device. The buffered data is preferably identical to raw ultrasound data, but may alternatively be processed data. The buffered data is preferably sent to a data selection control unit and an object motion calculation device, but alternatively could be sent to additional devices or any suitable alternative device. The data is preferably passed through the buffer for processing at substantially the same time as the ultrasound data is acquired, which functions to allow for dynamic acquisition in real-time. The buffered data may alternatively be a storage device for processing at times after the data was collected. The buffered data may be fed for processing at a real-time rate, at an accelerated rate, in a slow-motion rate, or at any suitable rate.

Step S234, which includes controlling data selection, functions to alter buffered data using the calculated object motion and providing the altered data for ultrasound processing. The data selection control unit preferably optimizes the raw data for data processing. Object motion measurements are preferably used during the optimization process as part of Step S230, and the ultrasound data is selected as part of S210 before being sent for ultrasound processing. As one example, frames of data may be selected at a frame rate determined by the object motion. As another example, spatial regions or portions of data may be selected that correspond to object motion thresholds, patterns, or any parameter related to object motion.

Additionally or alternatively, as shown in FIG. 5, the method 200 of the second embodiment may include the steps modifying a parameter of data formation S236 and forming data S216. Steps S236 and S216 are preferably identical to the Steps S136 and S116 of the first preferred embodiment respectively, except as noted below. In the variation where Steps S236 and 5216 are used in addition to Step S234, the selected data is preferably the data formed by S216. Alternatively, the buffered data may be formed by Step S216.

### 3. System

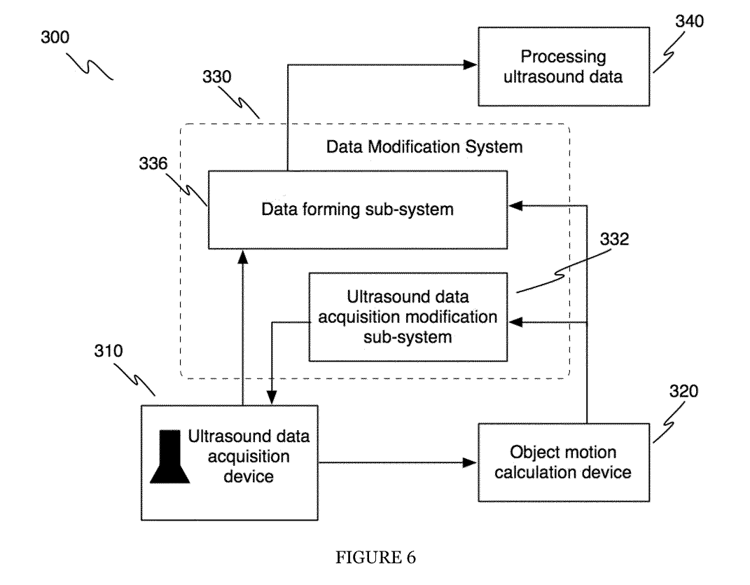

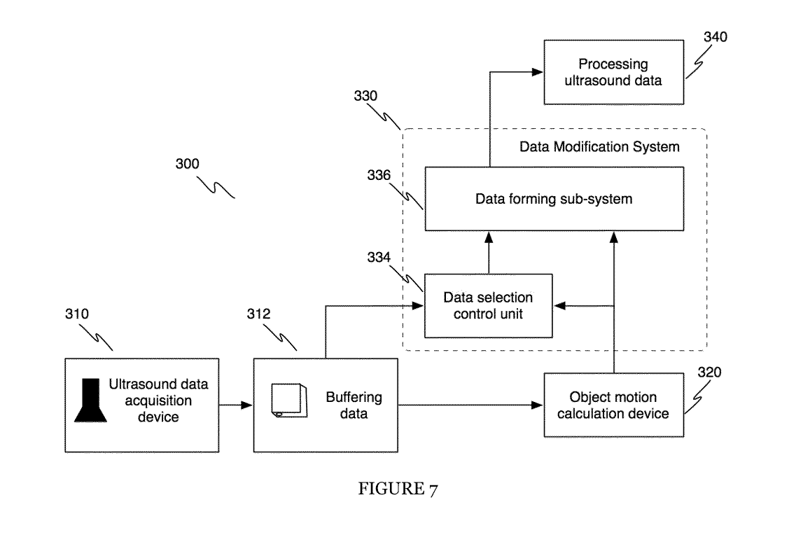

As shown in FIGS. 6 and 7, the system 300 of the preferred embodiment includes an ultrasound data generation device 310, an object motion calculation device 320, data modification system 330, and an ultrasound data processor 340. The system function to enable the dynamic acquisition of ultrasound data to use object motion to alter the acquired ultrasound data before processing. The ultrasound data generation device 310 preferably includes an ultrasound acquisition device that collects ultrasound signals during interrogation of an object (e.g., tissue). An ultrasound transducer preferably generates and senses the ultrasound signals. The sensed ultrasound signals are preferably converted into a raw ultrasound data file. Additionally or alternatively, a data buffer 312 may receive ultrasound data and provide that data to the rest of the system 300 as part of generating ultrasound data. The data buffer 312 preferably receives the data from an ultrasound acquisition device but may alternatively read a data storage device or receive the data from any suitable source. The object motion calculation device 320 is any suitable hardware or software device that is capable of performing the steps described above for Steps S120 or S220. The data modification system 330 preferably alters the input (i.e., control) or output of the ultrasound data generation device 310 (shown in FIG. 6) or alternatively the data buffer 312 (shown in FIG. 7). The data modification system 330 may additionally include sub-systems to perform any suitable combination of operations described above for Steps S132, S136, S116, S234, S236, and/or S216. The data modification system 130 may include an ultrasound data acquisition modification sub-system 332 that manipulates control inputs of the ultrasound data generation device 310. The data modification system 330 may include a data forming sub-system 336 that calculates data formation parameters using the output of the object motion calculation device 320 and forms acquired ultrasound data or buffered ultrasound data. In the alternative variation where a data buffer is used, a data selection control unit 334 preferably selects data from the ultrasound data generation device 310 output. The object motion calculation device 320, data modification system 330, and ultrasound data processor 340 may alternatively be realized through any suitable computer-readable medium and the components may be executed on a single or multiple hardware and software platforms.

An alternative embodiment preferably implements the above methods in a computer-readable medium storing computer-readable instructions. The instructions are preferably executed by computer-executable components for dynamically acquiring ultrasound data for processing. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method for acquiring and transforming ultrasound data comprising:
generating ultrasound data;
calculating object motion from the collected ultrasound data;
modifying a data generation parameter using the calculated object motion;
processing the ultrasound data related to the generated ultrasound data; and
outputting the processed ultrasound data.

2. The method of claim 1, wherein the step of calculating object motion includes performing speckle tracking.

3. The method of claim 1, wherein the step of modifying a data generation parameter includes adjusting operation of an ultrasound acquisition device.

4. The method of claim 3, further including adjusting an ultrasound beam property according to the calculated object motion.

5. The method of claim 3, further including adjusting the acquisition rate of an ultrasound acquisition device according to the calculated object motion.

6. The method of claim 3, wherein the step of modifying a data generation parameter further includes modifying a data formation parameter and wherein the step of generating ultrasound data includes forming ultrasound data sent for processing according to the data formation parameter.

7. The method of claim 6, wherein forming ultrasound data includes defining temporal and spatial sampling of ultrasound image data.

8. The method of claim 1, wherein generating ultrasound data includes buffering data from a data acquisition device.

9. The method of claim 8, wherein the data of the buffer is read at substantially the same time as the data is acquired by an ultrasound device

10. The method of claim 8, wherein buffering includes reading from a data storage device.

11. The method of claim 8, wherein the buffered data is 3D ultrasound data.

12. The method of claim 8, wherein the step of generating ultrasound data includes selecting buffered ultrasound data to send for processing according to the data generation parameter.

13. The method of claim 12, wherein selecting buffered ultrasound data includes optimizing data for processing.

14. The method of claim 12, wherein the step of modifying a data acquisition parameter further includes modifying a data formation parameter and wherein the step of generating ultrasound data includes forming ultrasound data sent for processing according to the data formation parameter.

15. A system for acquiring and transforming ultrasound data comprising:
an ultrasound data generation device that collects ultrasound data;
an object motion calculation device that calculates object motion from the ultrasound data;
a data modification system that uses the calculated object motion to modify a data generation parameter; and
a data processor that processes the ultrasound data supplied by the ultrasound generation device.

16. The system of claim 15, wherein the data modification system includes a control input of an ultrasound acquisition device of the ultrasound data generation device.

17. The system of claim 16, wherein the ultrasound acquisition device includes an ultrasound transducer that is at least partially manipulated by the control input.

18. The system of claim 15, wherein the data modification system accepts ultrasound data and modifies the data for the data processor.

19. The system of claim 18, wherein the data modification system includes a data forming sub-system that outputs ultrasound data images for the data processor.

20. The system of claim 15, wherein the ultrasound data generation device is a buffer of ultrasound data.
